(19) United States
(12) Patent Application Publication
(10) Pub. No.: US 2019/0248241 A1
(43) Pub. Date: Aug. 15, 2019

(54) EXTERNAL POWER VEHICLE PRECONDITIONING WITHOUT CHARGING

(71) Applicant: Ford Global Technologies, LLC, Dearborn, MI (US)

(72) Inventors: Charles Everett Badger, II, Westland, MI (US); Angel Fernando Porras, Dearborn, MI (US); Jordan Mazaira, Taylor, MI (US)

(21) Appl. No.: 15/892,613

(22) Filed: Feb. 9, 2018

(51) Int. Cl. B60L 1/08; B60L 11/18

(52) U.S. Cl. CPC B60L 1/08; B60L 11/1816; B60L 11/1875; B60L 11/1874

(57) ABSTRACT

An exemplary preconditioning method includes, among other things, preconditioning an electrified vehicle using power from an external source without charging a traction battery from the external source. An exemplary vehicle assembly includes, among other things, a conditioning system that preconditions an electrified vehicle using power from an external source, and a traction battery having a state of charge that does not increase as the conditioning system preconditions the electrified vehicle.

### TECHNICAL FIELD

This disclosure relates generally to preconditioning an electrified vehicle and, more particularly, to preconditioning the electrified vehicle with power from an external source without charging a traction battery of the electrified vehicle.

### BACKGROUND

Electrified vehicles differ from conventional motor vehicles because electrified vehicles are selectively driven using one or more electric machines powered by a traction battery. The electric machines can drive the electrified vehicles instead of, or in addition to, an internal combustion engine. Example electrified vehicles include hybrid electric vehicles (HEVs), plug-in hybrid electric vehicles (PHEVs), fuel cell vehicles (FCVs), and battery electric vehicles (BEVs).

The traction battery is a relatively high-voltage battery that selectively powers the electric machines and other electrical loads of the electrified vehicle. The traction battery can include battery arrays each including a plurality of interconnected battery cells that store energy. Some electrified vehicles, such as PHEVs, can charge the traction battery from an external power source.

Portions of the electrified vehicle can be preconditioned. For example, a cabin of the electrified vehicle can be heated or cooled prior to a drive cycle. The cabin is then more comfortable when a user enters the cabin to start the drive cycle. The traction battery can also be preconditioned. For example, the traction battery can be heated or cooled prior to beginning the drive cycle to ensure the traction battery operates within a preferred temperature range. The preconditioning can draw power from an external power source, such as a grid power source. The same external power source can be used to charge the traction battery, if desired.

### SUMMARY

A preconditioning method according to an exemplary aspect of the present disclosure includes, among other things, preconditioning an electrified vehicle using power from an external source without charging a traction battery from the external source.

A further non-limiting embodiment of the foregoing method includes activating a cabin conditioning system of the vehicle to heat or cool a cabin of the electrified vehicle.

A further non-limiting embodiment of any of the foregoing methods includes activating a battery conditioning system of the vehicle to heat or cool the traction battery.

In a further non-limiting embodiment of any of the foregoing methods, a drive cycle of the vehicle starts after the preconditioning without any intervening charging of the traction battery from the external source.

In a further non-limiting embodiment of any of the foregoing methods, a state of charge of the traction battery does not increase or decrease more than one-percent during the preconditioning.

In a further non-limiting embodiment of any of the foregoing methods, the external source is a grid power source.

A further non-limiting embodiment of any of the foregoing methods includes electrically coupling the vehicle to the external source prior to the preconditioning and electrically decoupling the vehicle from the external source after the preconditioning.

In a further non-limiting embodiment of any of the foregoing methods, a state of charge of the traction battery does not increase or decrease more than one-percent from the coupling to the decoupling.

In a further non-limiting embodiment of any of the foregoing methods, the electrically coupling includes directly connecting the vehicle to the external source with a charger, and the electrically decoupling comprises disconnecting the charger from the external source, the vehicle, or both.

In a further non-limiting embodiment of any of the foregoing methods, the external source is at a first location, and the method further includes, after the preconditioning, driving the vehicle from the first location to a different, second location. The method then charges the traction battery from an external source at the second location.

A vehicle assembly according to an exemplary aspect of the present disclosure includes, among other things, a conditioning system that preconditions an electrified vehicle using power from an external source, and a traction battery having a state of charge that does not increase or decrease as the conditioning system preconditions the electrified vehicle.

In a further non-limiting embodiment of the foregoing assembly, the conditioning system is a cabin conditioning system that is activated to heat or cool a cabin of the electrified vehicle.

In a further non-limiting embodiment of any of the foregoing assemblies, the conditioning system is a battery conditioning system that is activated to heat or cool the traction battery.

In a further non-limiting embodiment of any of the foregoing assemblies, the conditioning system preconditions the electrified vehicle prior to a starting a drive cycle of the electrified vehicle.

In a further non-limiting embodiment of any of the foregoing assemblies, the vehicle is configured to start a drive cycle after the conditioning system preconditions the electrified vehicle without any intervening charging of the traction battery from the external source.

In a further non-limiting embodiment of any of the foregoing assemblies, the state of charge of the traction battery does not increase or decrease more than one-percent as the conditioning system preconditions the electrified vehicle.

A further non-limiting embodiment of any of the foregoing assemblies includes a charger that electrically couples the electrified vehicle to the external source. The state of charge of the traction battery does not increase from the time the charger is electrically coupled to the electrified vehicle to the time the charger is electrically decoupled from the electrified vehicle.

In a further non-limiting embodiment of any of the foregoing assemblies, the state of charge of the traction battery does not increase or decrease more than one-percent as the conditioning system preconditions the electrified vehicle.

In a further non-limiting embodiment of any of the foregoing assemblies, the external source is at a first location. The traction battery is configured to be charged by an external source at a different, second location.

In a further non-limiting embodiment of any of the foregoing assemblies, a cost of power from the external source at the second location is less than a cost of power from the external source at the first location.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates an example electrified vehicle electrically coupled to an external power source.

FIG. 2 illustrates a highly schematic view of the electrified vehicle and the external power source of FIG. 1.

FIG. 3 illustrates a highly schematic view of the electrified vehicle of FIG. 1 coupled to a second external power source.

FIG. 4 illustrates the flow of an example preconditioning method.

### DETAILED DESCRIPTION

This disclosure relates generally to preconditioning areas of an electrified vehicle. In particular, the disclosure preconditions without charging a traction battery of the electrified vehicle. The charging can then occur at another location, such as a location where external power is provided at a lower cost.

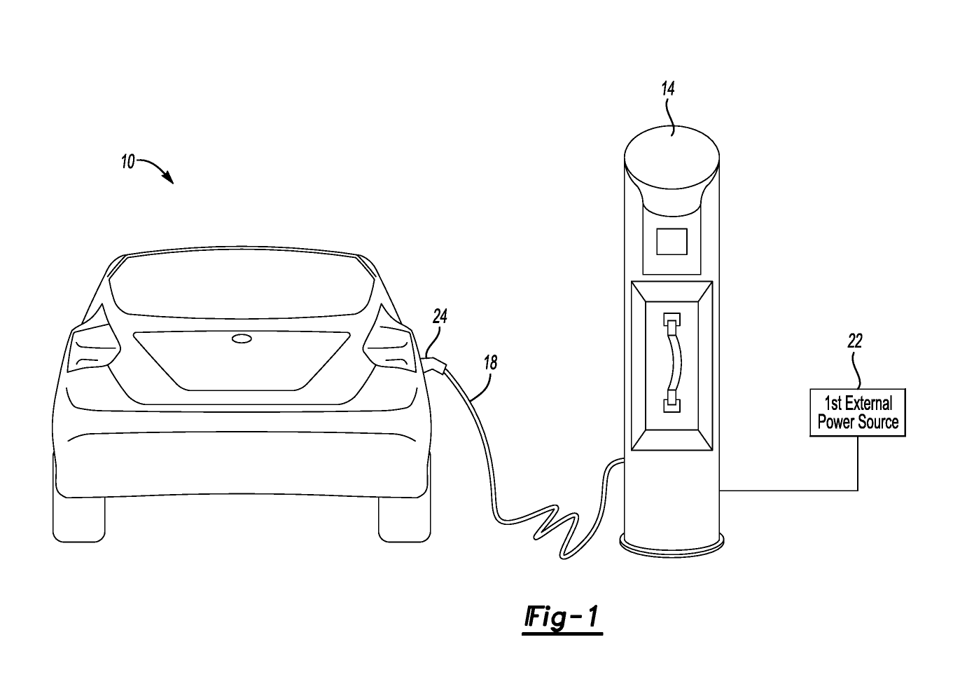

Referring to FIG. 1, an exemplary vehicle 10 is coupled to a charge station 14 with a charger 18. The charge station 14 draws power from a first external power source 22, which is a grid power source in this example. The charger 18 communicates power from the charge station 14 to the electrified vehicle 10. The power can move from the charger 18 through a charge port 24 of the electrified vehicle 10 to charge a traction battery of the electrified vehicle 10, to precondition areas of the electrified vehicle 10, or both.

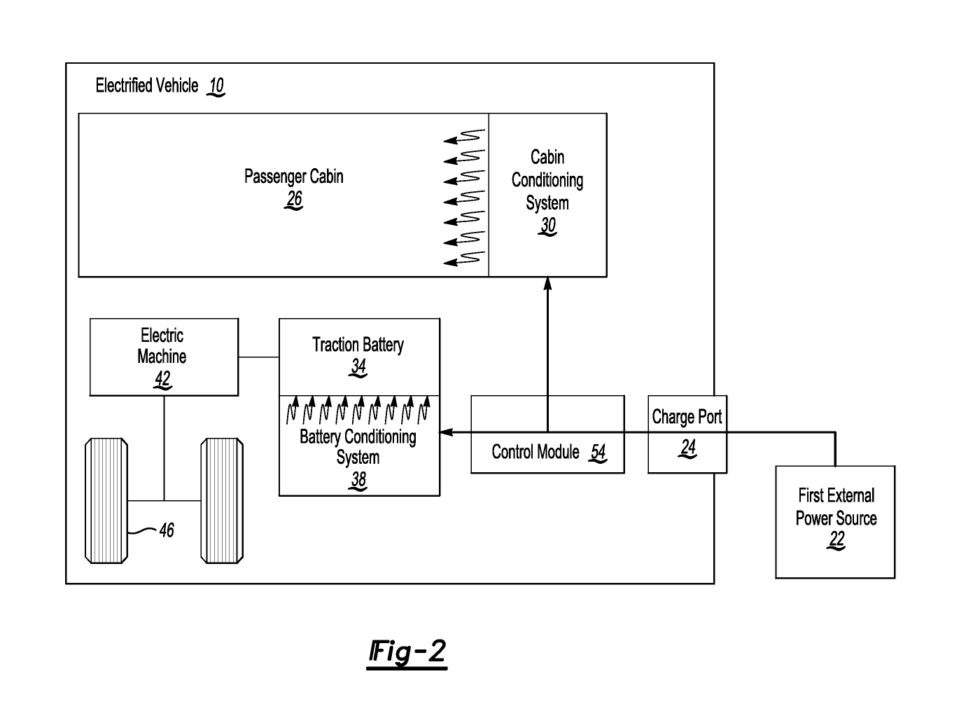

Referring now to FIG. 2, with continuing reference to FIG. 1, the electrified vehicle 10 includes a passenger cabin 26, a cabin conditioning system 30, a traction battery 34, a battery conditioning system 38, an electric machine 42, and a pair of drive wheels 46. A control module 54 within the electrified vehicle 10 distributes power from the first external power source 22 to different areas of the electrified vehicle 10.

The traction battery 34, in this example, can selectively power the electric machine 42. When powered, the electric machine 42 can generate torque to drive the drive wheels 46. The example vehicle 10 is a plug-in hybrid electric vehicle (PHEV). A power split powertrain of the vehicle 10 employs a first drive system and a second drive system. The first and second drive systems generate torque to drive one or more sets of vehicle drive wheels 46. The first drive system can include a combination of an internal combustion engine and the electric machine 42 as a generator. The second drive system can include at least the electric machine 42 as a motor, a generator, or both. The second drive system can further include the traction battery 34.

Although the example vehicle is a PHEV, the teachings of this disclosure could be utilized in connection with other types of electric vehicles that can be preconditioned and that include a chargeable traction battery. The vehicle 10 could be a battery electric vehicle (BEV) incorporating a traction battery, for example.

The passenger cabin 26 is an area of the electrified vehicle 10 directly occupied by a driver and passengers during a drive cycle. The cabin conditioning system 30 can be utilized to raise or lower a temperature of the passenger cabin 26. The cabin conditioning system 30 can be a heating, ventilation, and air conditioning (HVAC) system of the electrified vehicle 10, for example.

An operator of the electrified vehicle 10 can input a preferred temperature (or range of temperatures) for the passenger cabin 26. The cabin conditioning system 30 can then heat or cool the passenger cabin 26 to align the passenger cabin 26 temperature with the preferred temperature.

In some examples, the cabin conditioning system 30 preconditions the passenger cabin 26 in response to a go time. For example, if a driver of the electrified vehicle 10 programs the control module 54 to have a go time of 8:00 a.m., a drive cycle for the electrified vehicle 10 is assumed to begin at 8:00 a.m. In advance of the 8 a.m. go time, the control module 54 powers the cabin conditioning system 30 to precondition the passenger cabin 26 to the preferred temperature. Then, when the driver arrives to the passenger cabin 26 to begin the drive cycle at 8:00 a.m., the passenger cabin 26 is at the preferred temperature.

The passenger cabin 26 could also be preconditioned while the vehicle 10 is powered up after starting a drive cycle. For example, the vehicle 10 could be connected to grid power after starting a drive cycle. The vehicle 10 could be parked outside a library and connected to grid power to maintain a temperature in the passenger cabin 26, for example.

In the example of FIG. 2, the control module 54 is distributing power from the first external power source 22 to the cabin conditioning system 30, which is preconditioning the passenger cabin 26 by heating the passenger cabin 26. In another example, the cabin conditioning system 30 preconditions the passenger cabin 26 by cooling the passenger cabin 26. Other examples could include preconditioning the cabin 26 in other ways, such as by heating or cooling seats within the vehicle 10, adjusting the seats and steering wheel to a preferred position, etc.

Another area of the vehicle 10 that can be preconditioned is the traction battery 34. When preconditioning the traction battery 34, the traction battery 34 is heated or cooled prior to a drive cycle. The heating or cooling can change a temperature of the traction battery 34, or an area of the traction battery 34, to be within a preferred temperature range. The traction battery 34 operates most efficiently within the preferred temperature range. The battery conditioning system 38 may include a heater that raises a temperature of a battery coolant system to heat the traction battery 34, or that directly heats the traction battery 34. The battery conditioning system 38 may include an A/C compressor that along with a chiller may directly lower a temperature of the traction battery 34, or to indirectly lower the temperature of the traction battery 34 by cooling the battery coolant system. The battery conditioning system 38 can include both a heater and a chiller in some examples. The battery conditioning system 38 raises or lowers a temperature of the traction battery 34 to bring a temperature of the traction battery within an optimal temperature operating range. The traction battery 34 operates most efficiently within the preferred operating range. The preconditioning ensures that the traction battery 34 can be operating efficiently at the start of a drive cycle.

For example, on a cold day, the battery conditioning system 38 may heat the traction battery 34 to bring the traction battery 34 temperature to within the preferred operating range. The traction battery 34 can then operate efficiently and excess energy is not required from the traction battery 34 to raise the temperature of the traction battery 34 to the optimum operating range during the drive cycle.

In the example of FIG. 2, the control module 54 is distributing power from the first external power source 22 to the battery conditioning system 38, which is preconditioning the traction battery 34 by heating the traction battery 34. In another example, the battery conditioning system 38 preconditions the traction battery 34 by cooling the traction battery 34.

Notably, the traction battery 34 can be charged from the first external power source 22, which would increase a state of charge for the traction battery 34. However, as shown in FIG. 2, the control module 54 is not routing power from the first external power source 22 to the traction battery 34. That is, control module 54 is configured such that the traction battery 34 is not charged by the first external power source 22.

The configuring of the control module 54 to deliver power from the first external power source 22 for preconditioning, but not charging the traction battery 34 could be accomplished through activating a mode of the vehicle 10. The mode could be a NO CHARGE—PRECONDITION ONLY mode that an operator can selectively activate through a user interface within the passenger cabin 26, such as a human machine interface.

The vehicle in FIG. 2, has an activated NO CHARGE—PRECONDITION ONLY mode. The vehicle 10 is thus only pulling power from the first external power source 22 that is necessary to precondition. The operator may choose to activate the NO CHARGE—PRECONDITION ONLY mode because, for example, the cost of power from the first external power source 22 is relatively high and the user wants to delay a charge of the traction battery 34 until a less expensive source of external power is available. The NO CHARGE—PRECONDITION ONLY mode can remain active until the charger 18 is decoupled from the charge port 24.

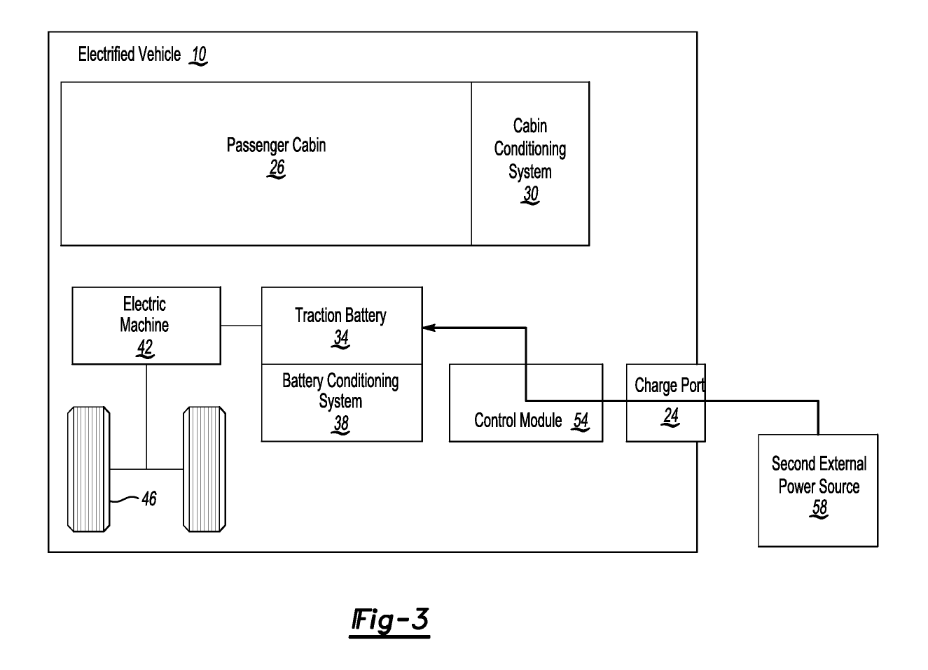

With reference now to FIG. 3, the electrified vehicle 10 has moved to another location. For purposes of this disclosure, the first external power source 22 is at a first location and a second external power source 58 is at a different, second location. The vehicle 10 underwent a drive cycle to move the vehicle 10 from the first location to the second location. The drive cycle begins, for purposes of this disclosure, when a driver enters the passenger cabin 26, keys-on the vehicle 10, and places the vehicle 10 in a drive gear. A drive cycle ends when the vehicle 10 is placed in park, the vehicle 10 is keyed-off, and the driver exits the passenger cabin 26.

The second external power source 58 provides, from the driver's perspective, a less expensive source of power than the first external power source 22. Accordingly, the driver authorizes the control module 54 to permit charging the traction battery 34 from the second external power source 58. The second external power source 58 could be, for example, an external power source at the driver's employer, which the driver is not directly charged for. The first external power source 22, in contrast, is at the driver's home, which the driver would likely be directly charged for. The second external power source 58 can be a grid power source.

In FIG. 3, the control module 54 could additionally direct power to the cabin conditioning system 30, the battery conditioning system 38, or both, to precondition the passenger cabin 26 and the traction battery 34 as required.

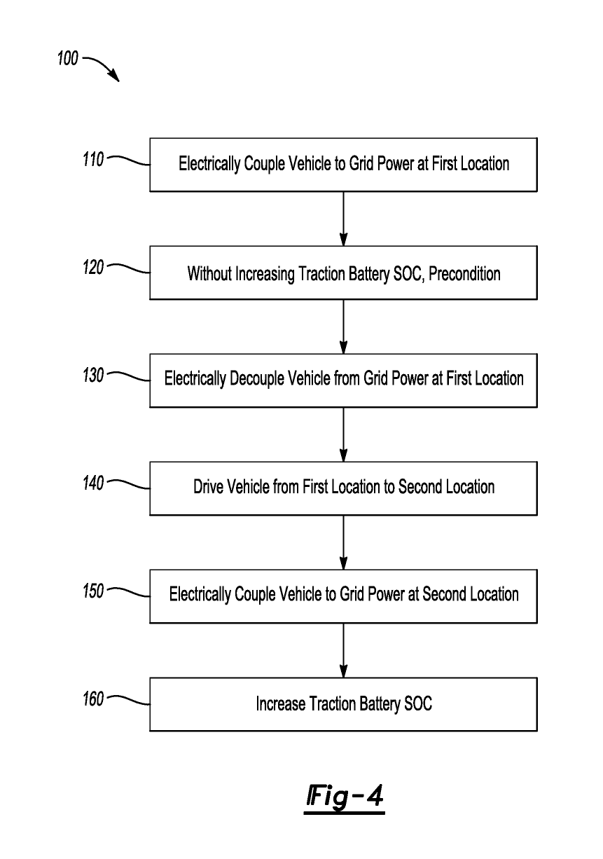

Referring now to FIG. 4, with continuing reference to FIGS. 1-3, an exemplary precharging method 100 begins at a step 110 where the electrified vehicle 10 is electrically coupled to an external (e.g., grid) power source at a first location. Next, at a step 120, the electrified vehicle 10 is preconditioned without charging the traction battery 34. The step 120 is represented by the schematic in FIG. 2.

For purposes of this disclosure, not charging the traction battery 34 means that a state of charge of the traction battery does not significantly increase or decrease. A significant increase or decrease could be considered to be a state of charge that increases or decreases more than 1%. Thus, in the example of FIG. 4, the traction battery state of charge does not increase or decrease more than 1% during the preconditioning.

At a step 130, the vehicle is electrically decoupled from the external power source at the first location. The electric decoupling can involve disconnecting the charger 18 from the charge port 24 of the vehicle 10.

A drive cycle then begins and, at a step 140, the vehicle drives from a first location, with the first external power source 22, to a second location, with the second external power source 58. A cost of power at the second external power source is less than a cost of a power for the driver at the first external power source.

Next, at a step 150, the charger 18 electrically couples the vehicle 10 to the second external power source 58 as is shown in FIG. 3. The control module 54 then routes power to increase a traction battery state of charge at a step 160. The step 160 could additionally include preconditioning the cabin, the traction battery, or both.

Features of the disclosed examples include permitting a preconditioning of a vehicle without charging a traction battery of the vehicle. The charging of the traction battery can be delayed until the vehicle is at a more cost-effective charging location. Permitting the preconditioning, however, permits the battery to operate within an optimum temperature range, the driver to have a passenger cabin at an appropriate temperature, or both.

Preconditioning, like a remote start, can ensure that the passenger cabin at a comfortable temperature before a drive. In electrified vehicles, because there is no engine or the engine is not used as much, there is often a heat source and/or a cooling source onboard that is powered from the main traction battery. Preconditioning of the cabin, while charging, may occur to limit the amount of energy needed from the traction battery in order to control the cabin temperature. This increases range by not having to heat or cool a large mass of air in the cabin and cabin interior from the energy in the traction battery, saving the energy for movement. In some examples, most of the energy when charging during preconditioning is used to cool or heat the passenger cabin. Some energy, however, is still used to charge the battery.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. A preconditioning method, comprising:
preconditioning an electrified vehicle using power from an external source without charging a traction battery from the external source.

2. The preconditioning method of claim 1, wherein the preconditioning includes activating a cabin conditioning system of the vehicle to heat or cool a cabin of the electrified vehicle.

3. The preconditioning method of claim 1, wherein the preconditioning includes activating a battery conditioning system of the vehicle to heat or cool the traction battery.

4. The preconditioning method of claim 1, wherein a drive cycle of the vehicle starts after the preconditioning without any intervening charging of the traction battery from the external source.

5. The preconditioning method of claim 1, wherein a state of charge of the traction battery does not increase or decrease more than one-percent during the preconditioning.

6. The preconditioning method of claim 1, wherein the external source is a grid power source.

7. The preconditioning method of claim 1, further comprising electrically coupling the vehicle to the external source prior to the preconditioning and electrically decoupling the vehicle from the external source after the preconditioning.

8. The preconditioning method of claim 7, wherein a state of charge of the traction battery does not increase or decrease more than one-percent from the coupling to the decoupling.

9. The preconditioning method of claim 7, wherein the electrically coupling comprises directly connecting the vehicle to the external source with a charger, and the electrically decoupling comprises disconnecting the charger from the external source, the vehicle, or both.

10. The preconditioning method of claim 1, wherein the external source is at a first location, and further comprising, after the preconditioning, driving the vehicle from the first location to a different, second location, and charging the traction battery from an external source at the second location.

11. A vehicle assembly, comprising:
a conditioning system that preconditions an electrified vehicle using power from an external source; and
a traction battery having a state of charge that does not increase or decrease as the conditioning system preconditions the electrified vehicle.

12. The vehicle assembly of claim 11, wherein the conditioning system is a cabin conditioning system that is activated to heat or cool a cabin of the electrified vehicle.

13. The vehicle assembly of claim 11, wherein the conditioning system is a battery conditioning system that is activated to heat or cool the traction battery.

14. The vehicle assembly of claim 11, wherein the conditioning system preconditions the electrified vehicle prior to a starting a drive cycle of the electrified vehicle.

15. The vehicle assembly of claim 11, wherein the vehicle is configured to start a drive cycle after the conditioning system preconditions the electrified vehicle without any intervening charging of the traction battery from the external source.

16. The vehicle assembly of claim 11, wherein the state of charge of the traction battery does not increase or decrease more than one-percent as the conditioning system preconditions the electrified vehicle.

17. The vehicle assembly of claim 11, further comprising a charger that electrically couples the electrified vehicle to the external source, wherein the state of charge of the traction battery does not increase from the time the charger is electrically coupled to the electrified vehicle to the time the charger is electrically decoupled from the electrified vehicle.

18. The vehicle assembly of claim 11, wherein the state of charge of the traction battery does not increase or decrease more than one-percent from as the conditioning system preconditions the electrified vehicle.

19. The vehicle assembly of claim 11, wherein the external source is at a first location, the traction battery configured to be charged by an external source at a different, second location.

20. The vehicle assembly of claim 19, wherein a cost of power from the external source at the second location is less than a cost of power from the external source at the first location.
